(19) United States
(12) Patent Application Publication
(10) Pub. No.: US 2008/0127181 A1
(43) Pub. Date: May 29, 2008

(54) Use of fixed-function device as general-purpose platform through virtualization

(75) Inventors: James E. Allard, Seattle, WA (US); Kenneth Dwight Krossa, Kirkland, WA (US); Todd G. Roshak, Redmond, WA (US); Bruno Silva, Clyde Hill, WA (US); Eric Traut, Bellevue, WA (US); Mike Neil, Issaquah, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/479,457

(22) Filed: Jun. 30, 2006

(51) Int. Cl. G06F 9/455

(52) U.S. Cl. 718/1

(57) ABSTRACT

Virtualization of features present on a general-purpose computing device in order to expand the use of a fixed-function device, such as a game console, into a general-purpose application platform. Hardware capabilities are virtualized in order to run a general-purpose operating system on a fixed-function device that typically lacks physical implementations of those hardware capabilities. The operating system runs using the virtualized capabilities, and existing applications are run in the environment provided by the operating system. Thus, a fixed-function device can be used to run ordinary, existing application software.

### BACKGROUND

Fixed-function devices such as game consoles, set-top boxes, cellular phones, portable entertainment devices, and certain other consumer electronics devices are generally designed to perform a limited set of well-defined functions. The software that controls these devices is built in such a way as to enable the intended functionality of the device. However, such software is normally built without regard to enabling an open-ended random assortment of functionality that is characteristic of a general-purpose computer. In other words, fixed-function devices are generally designed as specialized components with one (or a limited number) of purposes in mind.

It is desirable to be able to run an arbitrary mix of customer-selected application software on a fixed-function device, even if the application software is outside the function for which the fixed-function device was built—e.g., it would be desirable to run an E-mail program or word processor on a game console. Moreover, it is desirable to leverage existing application software from a variety of vendors, rather than porting or redesigning applications for a new environment. Furthermore, to the extent that such an application is designed to run under a particular operating system, it is desirable to run the application on a fixed-function device without having to port the operating system to the fixed-function device.

### SUMMARY

The subject matter described herein expands an existing fixed-function device into a generalized application platform. A virtualization layer runs on the fixed-function device and virtualizes one or more hardware capabilities that would normally be provided by a general-purpose computer but that are not provided by the fixed-function device. A general-purpose operating system, which normally expects certain hardware to be present on the computer on which it is running, is therefore able to run by using the virtualized hardware in place of those hardware elements that operating system needs but that the fixed-function device does not provide. By running a general-purpose operating system on the fixed-function device, applications that are designed to run in the environment provided by that operating system are also able to run on the device, thereby expanding the use of the fixed-function device to include many existing application programs.

### BRIEF DESCRIPTION OF THE DRAWINGS

FIG. 1 is a block diagram of an example fixed-function device that uses virtualization programming.

FIG. 2 is a block diagram showing the virtualization of graphics address remapping table (GART) features of a graphics processing unit (GPU).

FIG. 3 is a block diagram of a first example filesystem.

FIG. 4 is a block diagram of a second example filesystem that can be virtualized by virtualization programming using the first example filesystem of FIG. 3.

FIG. 5 is a block diagram of an example processor associated with an instruction set.

FIG. 6 is a diagram of example acts that can be performed on a fixed-function device.

FIG. 7 is a block diagram of an example scenario in which a multi-processor device and virtualization programming are used to virtualize a general-purpose device.

FIG. 8 is a block diagram of an example fixed-function device.

FIG. 9 is a block diagram of an example general-purpose computing device.

### DETAILED DESCRIPTION

### Overview

As fixed-function devices become more powerful and more prevalent, the impetus to transform them into general-purpose computing platforms grows. There are two traditional ways of effecting this transformation:

Create a new application platform for the device. This can be an extremely expensive proposition involving development and maintenance of the platform and its tools, and continued promotion of the platform to software vendors so that applications get written to the platform.

Porting an existing application platform to the device. MICROSOFT WINDOWS CE, JAVA, and Linux are all examples of software technologies which can be ported to fixed-function devices in order to provide a general-purpose application platform.

Both solutions above require a deeply embedded presence on the fixed-function device. These solutions often end up defining the overall character of the fixed-function device. The solutions in fact take over the fixed-function device, and the device in essence becomes a general-purpose platform and loses the character and advantages of a fixed-function device. Also, these solutions may not permit the use of common shrink-wrapped applications, since most applications would need to be customized, tailored, or ported if they were to be used with a new platform.

The subject matter described herein provides a virtualization platform that makes it possible to run a general-purpose operating system, such as the MICROSOFT WINDOWS operating system—and, therefore, the applications that run under the MICROSOFT WINDOWS operating system—on a fixed-function device such as a game console.

A typical game console, like most fixed-function devices, has hardware and software that are specifically designed to support a core set of usage scenarios, and little else. The subject matter described herein provides software that virtualizes sufficient features of a general-purpose computer to make it possible to run a general-purpose operating system on the fixed-function device. When such an operating system is run on the fixed-function device, it becomes possible to run a wide range of applications on the fixed-function device. Where the fixed-function device is a game console, the software that enables the use of a general-purpose operating system can be marketed at an ordinary title for that game console.

The subject matter described herein implementing a general-purpose virtualization engine that is capable of sustaining a general-purpose operating system, such as the MICROSOFT WINDOWS operating system. Through virtualization, it is possible to deliver, cost-effectively, a full general-purpose application platform on a fixed-function device.

### Virtualization Using Fixed-Function Device

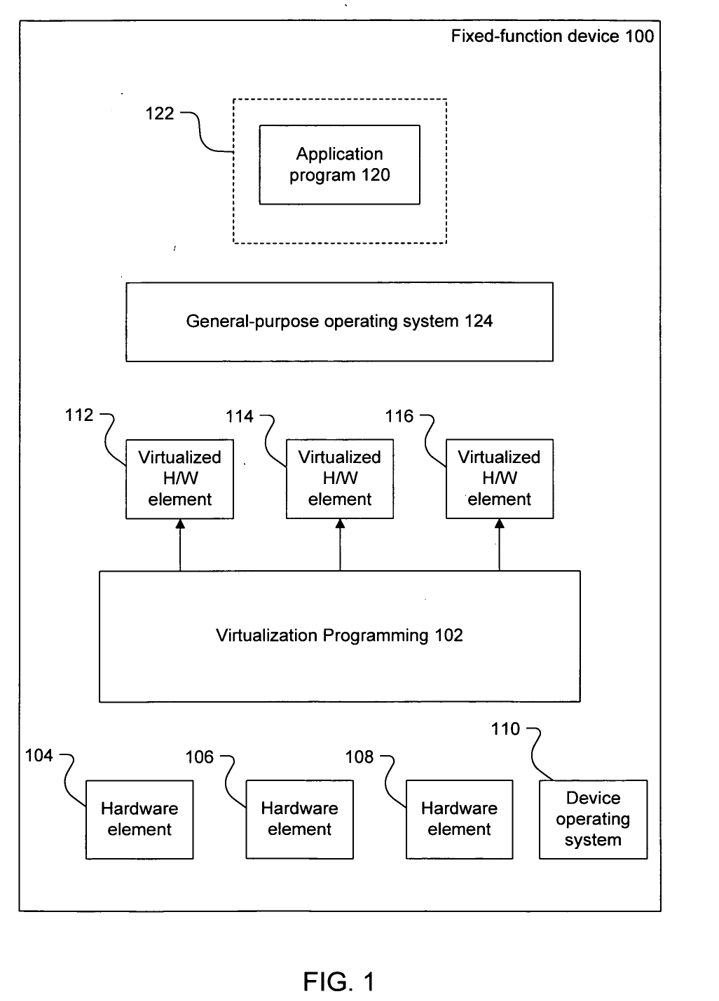

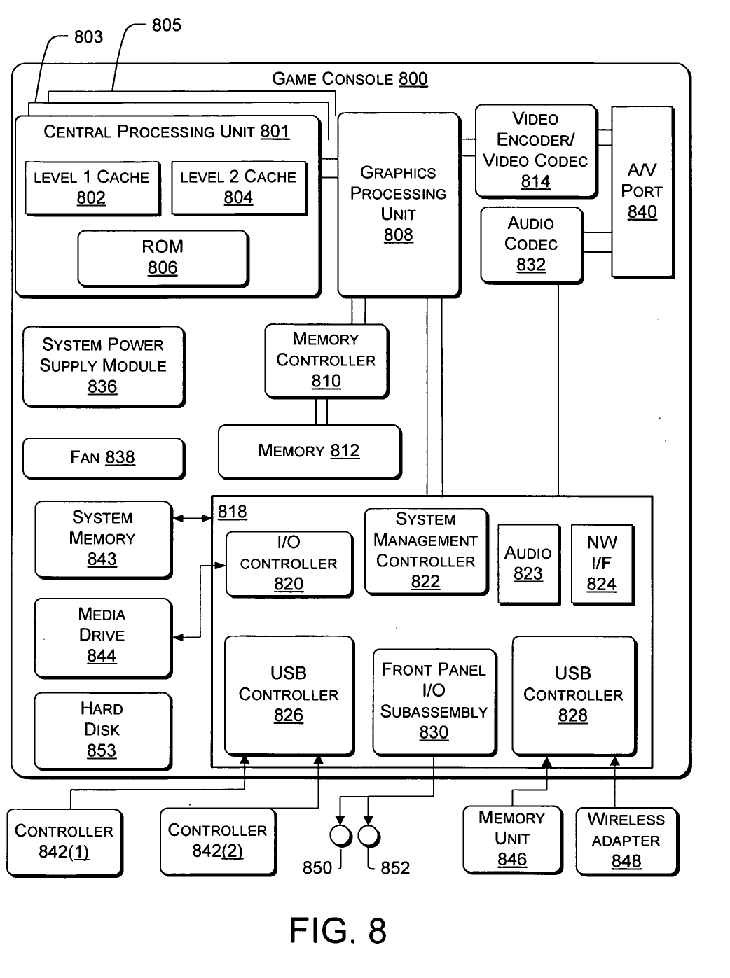

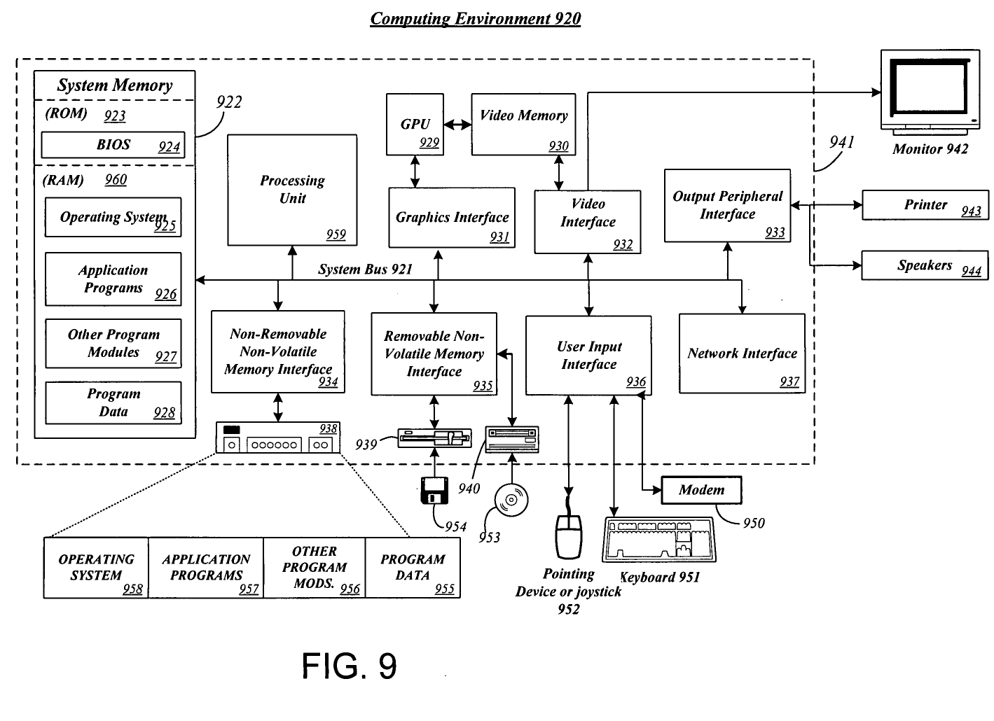

FIG. 1 shows an example fixed-function device 100, which uses virtualization programming 102. In general, fixed-function device 100 is a device that is dedicated to a particular purpose, in contradistinction to a general-purpose computer, such a computer 241 shown in FIG. 9. Fixed-function device 100 may have some features in common with a general-purpose computer, such as a processor and a memory, but generally lacks the full range of capabilities that are typical of a general-purpose computer. Game console 800 (shown in FIG. 8) is an example of a fixed-function device. Other examples of fixed-function devices include set-top DVD player, a wireless telephone, a set-top magnetic-disk-based time-shifting device, although these examples are not exhaustive.

Fixed-function device 100 generally include certain hardware elements, each of which provides various capabilities. As an example, three hardware elements 104, 106, and 108 are shown, although any number of hardware elements can be present. A processor (such as processing unit 959) is an example of a hardware element, and the ability to execute a certain instruction set is an example of that hardware element's capabilities. Other examples of hardware elements and their capabilities are discussed below, although it will be understood that the hardware elements and capabilities disclosed herein are not exhaustive of the concept. Fixed-function device 100 may also include an operating system 110 that manages the hardware of the fixed-function device; operating system 110 is typically a limited-function operating system, in contradistinction to general-purpose operating system 124, which is discussed below.

Virtualization programming 102 executes on fixed-function device 100 in order to virtualize hardware elements (and their respective capabilities) that are not physically provided by fixed-function device 100. As an example, three virtualized hardware elements 112, 114, and 116 are shown. Like the hardware elements discussed above, virtualized hardware elements 112, 114, and 116 are also each associated with certain capabilities. For example, virtualized hardware element 112 may be a processor of a particular type that has the capability to execute a certain instruction set, and this processor may be of a different model or type than the processor that is physically present at fixed-function device 100. In this case, virtualization programming 102 may be used to emulate a particular type of processor so that executable code prepared for that processor can be executed on fixed-function device 100, even though fixed-function device 100 does not have the native ability to execute such code. As another example, virtualized hardware element 114 may be a graphics processing unit (GPU), such as GPU 808 (shown in FIG. 8) is another example of a hardware element, and an example capability of such a hardware element is a graphics address remapping table (GART), and remapping functionalities that are commonly associated with a GART. Other examples of hardware elements that can be virtualized, and the capabilities of such hardware elements, are shown below, although, again, the examples described herein are not exhaustive. In general, virtualization programming 102 virtualizes a hardware element by using the hardware that actually exists within fixed-function device 100 to implement the capabilities of the hardware element that is being virtualized, and also by exposing an interface to that hardware element that can be controlled by some software (e.g., by a device driver) in the same manner as the physical hardware element could be controlled if the physical hardware element were present.

Application program 120 is a computer program. A word processor, an E-mail program, and a spreadsheet are examples of application program 120, although these examples are not exhaustive. Application program 120 relies, in some manner, on the presence of a hardware capability that is not physically present on the device (e.g., virtualized hardware capability 112). Thus, virtualized programming 102 may enable application program 120 to run on fixed-function device 100 by providing a virtualized version of a hardware capability that application program 120 relies on.

One example of such reliance on a hardware capability is that application program 120 directly uses, or is designed to work with, a particular piece of hardware. For example, if application program 120 is executable code that is executable by a processor of a particular model (or belonging to a particular family, such as the INTEL x86 family of processors), then application 120 relies in this manner on a particular hardware capability (i.e., application 120 relies on a processor that can execute the type of instructions contained in the executable file).

Another example of reliance on a hardware capability is that application 120 may be designed to execute in an environment 122 that is provided by general-purpose operating system 124, where general-purpose operating system 124 makes use of a particular hardware capability. This indirect reliance on a hardware capability is nevertheless an example of application program 120's relying on the hardware capability (even where application 120 does not use the hardware capability directly). As a particular example, application 120 may be designed to execute in the environment provided by a version of the MICROSOFT WINDOWS operating system, and the MICROSOFT WINDOWS operating system may rely on some hardware (e.g., a graphics processor having a GART), which is not provided physically by fixed-function device 100, but that can be virtualized by virtualization programming 102. It should be noted that—inasmuch as many programs are designed to run in an environment provided by a particular operating system—if a goal is to run normal applications on a fixed-function device (such as on a game console), it may be desirable to virtualize sufficient hardware so that a general-purpose operating system can run on the fixed-function device, and then to run that operating system on the device so that existing applications can run on that operating system.

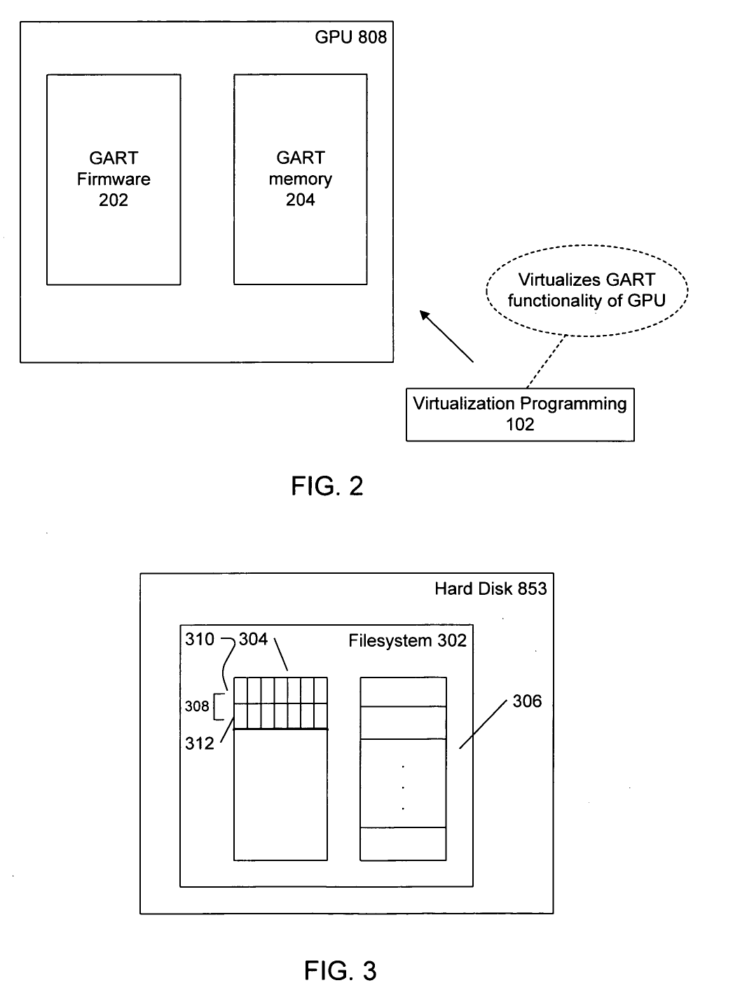

FIGS. 2-5 depict particular examples of hardware that can be provided either physically, or that can be virtualized by virtualization programming 102.

FIG. 2 shows a GPU 808, which provides the functionality associated with a GART. In particular, GPU 108 has a GART memory 204 which is used to store certain mapping information pertaining to the location of graphics information in a general system memory. GPU 108 also has GART firmware that actually performs the remapping of the graphics information, when that information is needed by GPU 808. A general-purpose computer typically includes a physical GPU 808 which performs the functionality of a GART. However, virtualization programming 102 may be used to virtualize a GART—e.g., by using general system memory to store the remapping information, and by implementing the remapping function as software that executes on the general-purpose processing unit of the device on which the virtualization is being performed (such as fixed-function device 100, shown in FIG. 1).

FIG. 3 shows a hard disk 853, on which a first filesystem 302 is implemented. In the example shown, filesystem 302 has a directory table 304, and a set of storage blocks 306. Directory table identifies the names of the files stored in file system 302, and also identifies the particular blocks 306 in which those files are stored. The nature of filesystem 302 may be such that it imposes limits on the files, such as on the length of each file name, or on the size of each file. In the example shown, each file is represented by an element 308 of directory table 304, where field 310 stores the file name, and field 312 stores an array listing the blocks that make up the file; since field 310, in the example shown, contains only a fixed amount of space to store the file name, and since field 312, in the example shown, can only identify a fixed number of storage blocks, this structure effectively limits both the length of a file name and the size of a file. It will be understood that filesystem 302 is merely an example of a filesystem, and is not limiting of the subject matter disclosed herein. Moreover, the limits (i.e., as to file name length and file size) are merely examples of limits that could be imposed by a file system, and the depicted structure of directory table 304 that effectively imposes those limits is merely one example as to how such limits could arise.

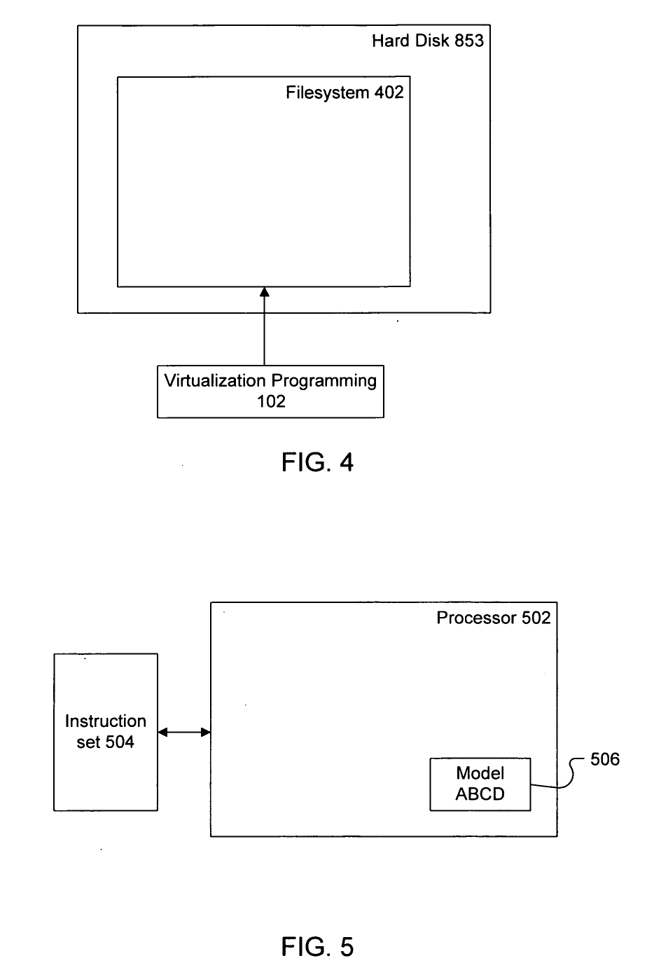

FIG. 4 shows how virtualization programming 102 can be used to implement a second filesystem 402 on hard disk 853, which is different from first filesystem 402. Filesystem 402 may lack some of the limits imposed by filesystem 302. For example, if filesystem 302 imposes limits on file name length and file size, filesystem 402 may lack one or both of those limits. Inasmuch as filesystem 302 may be the filesystem that physically exists on a hard disk of a fixed-function device, virtualization programming 102 may use filesystem 302 to implement filesystem 402. For example, virtualization programming may create files within filesystem 302 in order to store information that enables filesystem 402 to expose the capability to use arbitrary-length file names and/or arbitrary-size files, even though the underlying files are actually being stored in filesystem 302 in which limits on file name length and file size may be imposed.

FIG. 5 shows an example of a processor 502, which processes instructions from a particular instruction set 504. Processor 502 is of a particular model 504, or is from a particular family of processors. (E.g., the INTEL x86 is a family of processors; the INTEL PENTIUM M is a model from that family.) Processor 502's capability is, among other things, the ability to execute instructions from set 504. If there is executable code written in instruction set 504, and if a physical instance of processor 502 is present, then the executable code can be executed directly by processor 502. Alternatively, virtualization programming may be used to emulate processor 502, thereby providing, in essence, a virtual machine on which the executable code may execute.

### Example Actions Performable on a Fixed-Function Device

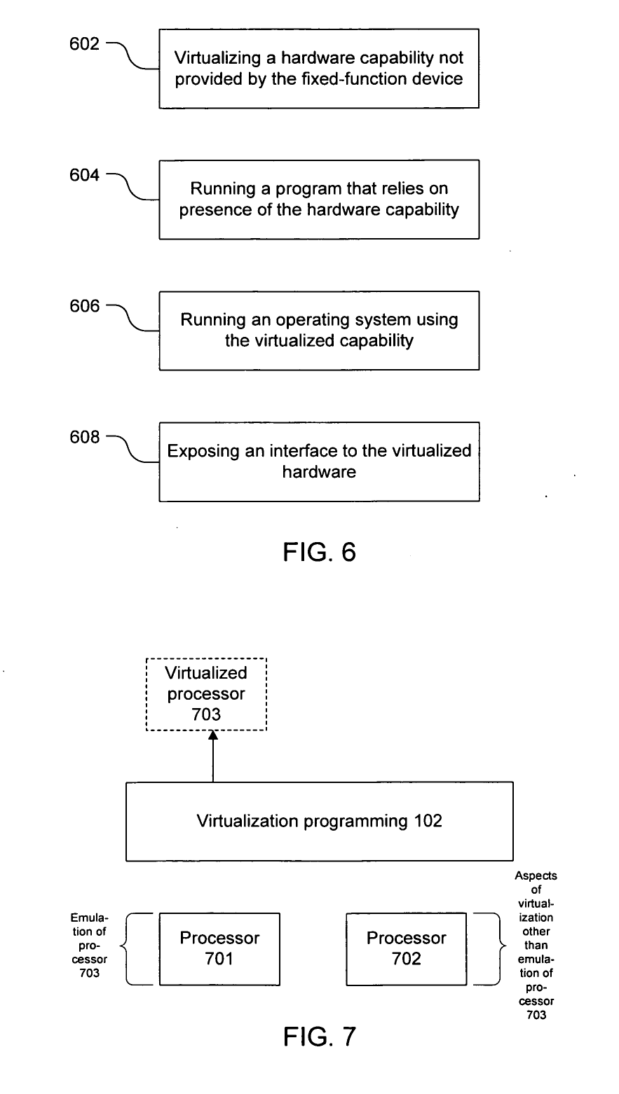

FIG. 6 shows asset of example acts that are performable on a fixed-function device. It should be noted that, in any given instance, is it not necessary to perform all of the-acts depicted in FIG. 6; rather, either some or all of those acts may be performed. Moreover, they may be performed in any order.

Block 602 shows the act of virtualizing a hardware capability that is not provided by the fixed-function device. For example, virtualization programming may be used to implement a virtual instance of some hardware element that is not physically present on a fixed-function device. FIGS. 2-5 show examples of such hardware elements and capabilities, although such examples are not exhaustive.

Block 604 shows the act of running a program that relies on the presence of a particular hardware capability—e.g., the hardware capability that is virtualized in block 602. As previously noted, one example of a program relying on a hardware capability is that the program actually uses the hardware, as in the example where the hardware is a particular processor and the program is written for the instruction set of that processor.

Block 606 shows the act of running an operating system (e.g., a general-purpose operating system) that uses the hardware capability that is virtualized in block 602. As also previously noted, another example of a program relying on a hardware capability is that the program is designed or adapted to run in an operating environment provided by a particular operating system (e.g., a general-purpose operating system), and the operating system itself uses the hardware capability. Block 606 depicts the act of running such an operating system.

Block 608 shows the act of exposing an interface to the hardware that is virtualized in block 602. Exposing such an interface allows the virtualized hardware to be interacted with in the same manner as one would interact with the physical hardware if the physical hardware were present. For example, if the hardware to be virtualized is a graphics processor, then a device driver for the graphics processor should, normally, be able to interact with the virtualized graphics processor in the same manner as it would interact with a physical instance of the graphics processor. From the perspective of the driver, the virtualized graphics processor may be indistinguishable from a physical graphics processor, as a consequence of exposing the right interface to the virtualized graphics processor.

### Example Use of a Multi-Processor Fixed Function Device

FIG. 7 shows an example in which a fixed-function device is a multi-processor device that is used to virtualize a general-purpose device.

In this example the fixed-function device has two processors 701 and 702. Virtualization programming 102, as described in connection with FIG. 1 above, runs on the fixed-function device. Virtualized processor 703 is the processor associated with the general-purpose device whose capabilities are being virtualized. Virtualized processor 703 may be of a different model or family from the processors 701 and 702 that are provided by the fixed-function device, and thus virtualization programming 102 emulates processor 703.

Inasmuch as virtualization programming may be performing various virtualization tasks—some of which are related to emulating processor 703 and some of which are not—it may be desirable to assign one processor (e.g., processor 701) to perform actions related to emulating processor 703, and to assign a different processor (e.g., processor 702) to perform other virtualization-related actions performed by virtualization programming 102. In this sense, processor 701 is dedicated to the emulation of processor 703, thereby making processor 102 available for other virtualization tasks.

### Game Console as an Example of a Fixed-Function Device

Referring to FIG. 8, there is shown a block diagram of a game console 800, in which many computerized processes, including those of various aspects of the subject matter described herein, may be implemented. Game console 800 is an example of the fixed-function device of FIG. 1, although, as noted above, a game console is only one example of a fixed-function device. Game console 800 has a central processing unit (CPU) 801 having a level 1 (L1) cache 802, a level 2 (L2) cache 804, and a flash ROM (Read-only Memory) 806. The level 1 cache 802 and level 2 cache 804 temporarily store data and hence reduce the number of memory access cycles, thereby improving processing speed and throughput. The flash ROM 806 may store executable code that is loaded during an initial phase of a boot process when the game console 800 is initially powered. Alternatively, the executable code that is loaded during the initial boot phase may be stored in a FLASH memory device (not shown). Further, ROM 806 may be located separate from CPU 801. Game console 800 may, optionally, be a multi-processor system; for example game console 800 may have three processors 801, 803, and 805, where processors 803 and 805 have similar or identical components to processor 801.

A graphics processing unit (GPU) 808 and a video encoder/video codec (coder/decoder) 814 form a video processing pipeline for high speed and high resolution graphics processing. Data is carried from the graphics processing unit 808 to the video encoder/video codec 814 via a bus. The video processing pipeline outputs data to an A/V (audio/video) port 840 for transmission to a television or other display. A memory controller 810 is connected to the GPU 808 and CPU 801 to facilitate processor access to various types of memory 812, such as, but not limited to, a RAM (Random Access Memory).

Game console 800 includes an 1/0 controller 820, a system management controller 822, an audio processing unit 823, a network interface controller 824, a first USB host controller 826, a second USB controller 828 and a front panel I/O subassembly 830 that may be implemented on a module 818. The USB controllers 826 and 828 serve as hosts for peripheral controllers 842(1)-842(2), a wireless adapter 848, and an external memory unit 846 (e.g., flash memory, external CD/DVD ROM drive, removable media, etc.). The network interface 824 and/or wireless adapter 848 provide access to a network (e.g., the Internet, home network, etc.) and may be any of a wide variety of various wired or wireless interface components including an Ethernet card, a modem, a Bluetooth module, a cable modem, and the like.

System memory 843 is provided to store application data that is loaded during the boot process. A media drive 844 is provided and may comprise a DVD/CD drive, hard drive, or other removable media drive, etc. The media drive 844 may be internal or external to the game console 800. When media drive 844 is a drive or reader for removable media (such as removable optical disks, or flash cartridges), then media drive 844 is an example of an interface onto which (or into which) media are mountable for reading. Application data may be accessed via the media drive 844 for execution, playback, etc. by game console 800. Media drive 844 is connected to the I/O controller 820 via a bus, such as a Serial ATA bus or other high speed connection (e.g., IEEE 1394). While media drive 844 may generally refer to various storage embodiments (e.g., hard disk, removable optical disk drive, etc.), game console 800 may specifically include a hard disk 852, which can be used to store game data, application data, or other types of data, and on which the filesystems depicted in FIGS. 3 and 4 may be implemented.

The system management controller 822 provides a variety of service functions related to assuring availability of the game console 800. The audio processing unit 823 and an audio codec 832 form a corresponding audio processing pipeline with high fidelity, 3D, surround, and stereo audio processing according to aspects of the present subject matter described herein. Audio data is carried between the audio processing unit 823 and the audio codec 826 via a communication link. The audio processing pipeline outputs data to the A/V port 840 for reproduction by an external audio player or device having audio capabilities.

The front panel I/O subassembly 830 supports the functionality of the power button 850 and the eject button 852, as well as any LEDs (light emitting diodes) or other indicators exposed on the outer surface of the game console 800. A system power supply module 836 provides power to the components of the game console 800. A fan 838 cools the circuitry within the game console 800.

The CPU 801, GPU 808, memory controller 810, and various other components within the game console 800 are interconnected via one or more buses, including serial and parallel buses, a memory bus, a peripheral bus, and a processor or local bus using any of a variety of bus architectures.

When the game console 800 is powered on or rebooted, application data may be loaded from the system memory 843 into memory 812 and/or caches 802, 804 and executed on the CPU 801. The application may present a graphical user interface that provides a consistent user experience when navigating to different media types available on the game console 800. In operation, applications and/or other media contained within the media drive 844 may be launched or played from the media drive 844 to provide additional functionalities to the game console 800.

The game console 800 may be operated as a standalone system by simply connecting the system to a television or other display. In this standalone mode, the game console 800 may allow one or more users to interact with the system, watch movies, listen to music, and the like. However, with the integration of broadband connectivity made available through the network interface 824 or the wireless adapter 848, the game console 800 may further be operated as a participant in a larger network community.

### Example Computing Environment

As noted above, it may be desirable to virtualize features present in a general-purpose computing device. FIG. 9 shows an example of such a computing device. Referring to FIG. 9, shown is a block diagram representing an example computing device. The computing system environment 220 is only one example of a suitable computing environment and is not intended to suggest any limitation as to the scope of use or functionality of the subject matter disclosed herein. Neither should the computing environment 220 be interpreted as having any dependency or requirement relating to any one or combination of components illustrated in the example operating environment 220.

Aspects of the subject matter described herein are operational with numerous other general purpose or special purpose computing system environments or configurations. Examples of well known computing systems, environments, and/or configurations that may be suitable for use with the subject matter described herein include, but are not limited to, personal computers, server computers, hand-held or laptop devices, multiprocessor systems, microprocessor-based systems, set top boxes, programmable consumer electronics, network. PCs, minicomputers, mainframe computers, distributed computing environments that include any of the above systems or devices, and the like.

An example system for implementing aspects of the subject matter described herein includes a general purpose computing device in the form of a computer 941. Components of computer 941 may include, but are not limited to, a processing unit 959, a system memory 922, and a system bus 921 that couples various system components including the system memory to the processing unit 959. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 941 typically includes a variety of computer readable media. Computer readable media can be any available media that can be accessed by computer 941 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 941. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 922 includes computer storage media in the form of volatile and/or nonvolatile memory such as read only memory (ROM) 923 and random access memory (RAM) 960. A basic input/output system 924 (BIOS), containing the basic routines that help to transfer information between elements within computer 941, such as during start-up, is typically stored in ROM 923. RAM 960 typically contains data and/or program modules that are immediately accessible to and/or presently being operated on by processing unit 959. By way of example, and not limitation, FIG. 9 illustrates operating system 925, application programs 926, other program modules 927, and program data 928.

The computer 941 may also include other removable/non-removable, volatile/nonvolatile computer storage media. By way of example only, FIG. 9 illustrates a hard disk drive 938 that reads from or writes to non-removable, nonvolatile magnetic media, a magnetic disk drive 939 that reads from or writes to a removable, nonvolatile magnetic disk 954, and an optical disk drive 940 that reads from or writes to a removable, nonvolatile optical disk 953 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 938 is typically connected to the system bus 921 through a non-removable memory interface such as interface 934, and magnetic disk drive 939 and optical disk drive 940 are typically connected to the system bus 921 by a removable memory interface, such as interface 935.

The drives and their associated computer storage media discussed above and illustrated in FIG. 9, provide storage of computer readable instructions, data structures, program modules and other data for the computer 941. In FIG. 9, for example, hard disk drive 938 is illustrated as storing operating system 958, application programs 957, other program modules 956, and program data 955. Note that these components can either be the same as or different from operating system 925, application programs 926, other program modules 927, and program data 928. Operating system 958, application programs 957, other program modules 956, and program data 955 are given different numbers here to illustrate that, at a minimum, they are different copies. A user may enter commands and information into the computer 941 through input devices such as a keyboard 951 and pointing device 952, commonly referred to as a mouse, trackball or touch pad. Other input devices (not shown) may include a microphone, joystick, game pad, satellite dish, scanner, or the like. These and other input devices are often connected to the processing unit 959 through a user input interface 936 that is coupled to the system bus, but may be connected by other interface and bus structures, such as a parallel port, game port or a universal serial bus (USB). A monitor 942 or other type of display device is also connected to the system bus 921 via an interface, such as a video interface 932. In addition to the monitor, computers may also include other peripheral output devices such as speakers 944 and printer 943, which may be connected through an output peripheral interface 933.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is Claimed:

1. A method of facilitating the running of a program on a fixed-function device, the method comprising:
virtualizing at least one hardware capability that is not provided by said fixed-function device, whereby a virtualized capability is provided; and
running, on said fixed-function device and by using said virtualized capability, a program that relies on the presence of said hardware capability.

2. The method of claim 1, wherein the program comprises an application that runs in an environment provided by an operating system, and wherein the method further comprises:
using said virtualized capability to run said operating system, wherein said operating system relies on the presence of said hardware capability and uses said virtualized capability in place of said hardware capability.

3. The method of claim 1, wherein said hardware capability comprises the ability to execute an instruction set associated with a specific model of processor or family of processors, and wherein said virtualizing of said at least one hardware capability comprises emulating said processor.

4. The method of claim 1, wherein said hardware capability comprises a hardware-implemented graphics address remapping table (GART), and wherein said virtualizing comprises using software to provide a GART.

5. The method of claim 1, wherein the fixed-function device comprises a hard disk, wherein the fixed-function device implements a first filesystem on said hard disk, said first filesystem imposing one or more of the following:
a limit on the size of files that may be stored on said hard disk; and
a limit on the length of file names that may be used for files stored on said hard disk;
and wherein said virtualizing comprises using said first filesystem to implement a second filesystem that lacks at least one of the aforesaid limits that is imposed by said first filesystem.

6. The method of claim 1, wherein the fixed-function device is a multi-processor device that comprises at least a first processor and a second processor, wherein said hardware capability comprises the ability to execute an instruction set associated with a third processor, said third processor being one of a specific model of processor or family of processors, and wherein said virtualizing comprises:
using said first processor to run an emulator that emulates said third processor;
using said second processor to perform actions that relate to aspects of said virtualizing other than emulation of said third processor.

7. The method of claim 1, further comprising:
providing a Universal Serial Bus (USB) driver for a USB device that is not supported by the fixed-function device.

8. One or more computer storage media collectively encoded with computer-executable instructions that are executable on a fixed-function device to perform acts comprising:
exposing an interface associated with a hardware element that is not provided by said fixed-function device;
using the fixed-function device to provide one or more capabilities that would be provided by said hardware element if said hardware element were present at said fixed-function device, whereby a program that relies on said one or more capabilities becomes runnable on said fixed-function device.

9. The one or more computer storage media of claim 8, wherein the program comprises an application that runs in an environment provided by an operating system, and wherein the acts further comprises:
using the fixed-function device to run said operating system, wherein said operating system relies on said one or more capabilities, and wherein the program relies on said one or more capabilities by virtue of relying on the environment provided by said operating system.

10. The one or more computer storage media of claim 8, wherein said one or more capabilities comprise the ability to execute an instruction set associated with a specific model of processor or family of processors, and wherein said acts comprise emulating said processor.

11. The one or more computer storage media of claim 8, wherein said one or more capabilities comprise a graphics address remapping table (GART), and wherein said acts comprise using the fixed-function device to provide a GART.

12. The one or more computer storage media of claim 8, wherein the fixed-function device comprises a hard disk, wherein the fixed-function device implements a first filesystem on said hard disk, said first filesystem imposing one or more of the following:
a limit on the size of files that may be stored on said hard disk; and
a limit on the length of file names that may be used for files stored on said hard disk;
and wherein said acts comprise using said first filesystem to implement a second filesystem that lacks at least one of the aforesaid limits that is imposed by said first filesystem.

13. The one or more computer storage media of claim 8, wherein the fixed-function device is a game console that includes an interface for reading removable media of a type on which game code and data are commonly purchased for the fixed-function device, and wherein said one or more computer storage media are removable media that are mountable on said interface.

14. A fixed-function device comprising:
one or more first hardware elements;
a removable media drive or interface that reads removable media;
programming that virtualizes at least one second hardware element that is not present at said fixed-function device, whereby a virtualized instance of said at least one second hardware element is provided by said programming; and
an application program that relies on said at least one second hardware element, said application being executable when said programming is providing said virtualized instance of said at least one second hardware element.

15. The fixed-function device of claim 14, further comprising an operating system that provides an environment in which said application program runs, wherein said operating system relies on said at least one second hardware element and uses said virtualized instance of said at least one second hardware element, wherein said application program relies on said at least one second hardware element by virtue of relying on said operating system to provide said environment.

16. The fixed-function device of claim 14, wherein said at least one second hardware element comprises a processor of a particular model or belonging to a particular family, and wherein said virtualized instance of said at least one second hardware element comprises a virtual machine that emulates said processor.

17. The fixed-function device of claim 14, wherein said at least one second hardware element comprises a graphics address remapping table (GART), and wherein said virtualized instance of said at least one second hardware element comprises a software implementation of said GART that runs on the fixed-function device.

18. The fixed-function device of claim 14, wherein the fixed-function device comprises a hard disk, wherein the fixed-function device implements a first filesystem on said hard disk, said first filesystem imposing one or more of the following:
a limit on the size of files that may be stored on said hard disk; and
a limit on the length of file names that may be used for files stored on said hard disk;
and wherein said programming uses said first filesystem to implement a second filesystem that lacks at least one of the aforesaid limits that is imposed by said first filesystem.

19. The fixed-function device of claim 14, wherein the fixed-function device is a multi-processor device that comprises at least a first processor and a second processor, and wherein said programming emulates a single-processor device whose single processor is a third processor, said third processor being one of said at least one second hardware elements, said programming using said first processor to emulate said third processor, and said programming using said second processor to emulate at least one of said second hardware elements other than said third processor, wherein said first processor is dedicated to the emulation of said third processor.

20. The fixed-function device of claim 14, wherein the fixed-function device is a game console that includes an interface for reading removable media, and wherein said programming is stored on a removable medium that mounts on or in said interface.
